(19) United States
(12) Patent Application Publication
(10) Pub. No.: US 2004/0127155 A1
(43) Pub. Date: Jul. 1, 2004

(54) Auxiliary ventilation hole device for sash window

(76) Inventor: Tosiharu Morisono, Tokyo (JP)

Correspondence Address: MORISONO TOSIHARU, 37-13, kyodo 5-chome, SETAGAYA-KU, TOKYO, 156-0052, JP

(21) Appl. No.: 10/383,788

(22) Filed: Feb. 3, 2003

(30) Foreign Application Priority Data
Jun. 12, 2001 (WO) PCT/JP01/04933

(51) Int. Cl. E06B 7/02

(52) U.S. Cl. 454/196

(57) ABSTRACT

Because of holes made through the protection board which prevents rain from coming into the room, outside air is able to come through. Therefore the board provides good ventilation and a good environment even when it is raining. As the ventilator on the board is designed to face the original window glass, raindrops can hardly come into the room. When the board is not being used, it is capable of being folded away on its hinges.

### TECHNICAL FIELD

The present invention relates to ventilation which is contrived so that rain can be prevented from blowing into a room and only outside air enters the room.

### BACKGROUND ART

When conventional sash windows are opened during rainy weather, rain blows inside. Thus the window cannot be opened, leading to poor air circulation and impaired ventilation.

### DISCLOSURE OF THE INVENTION

The present invention is provided with ventilation holes through which air may enter in one side of the folded surfaces of a rain entrance prevention plate. Hinges are provided on one edge of the rain entrance prevention plate via vertical sliding type fixing members with elongated holes for fixing this prevention plate to a pre-existing window frame, these hinges being provided with screw holes with a keyhole shape in order that the hinges can be easily attached to the pre-existing window frame. In order to prevent vibration in this prevention plate, a folding vibration proofing device in an inverted C shape is inserted into a groove cut into the vertical frame of the sash window to prevent vibration, and a vibration proofing incision (9) is provided for fastening the lower sliding type fixing member to a sash window rail.

### BRIEF DESCRIPTION OF THE DRAWINGS

FIG. 1 is a perspective view of the present invention;

FIG. 2 is a plan view thereof;

FIG. 3 is a front view thereof;

FIG. 4 is a view showing an example of usage seen from above; and

FIG. 5 is a view showing an example of storage seen from above.

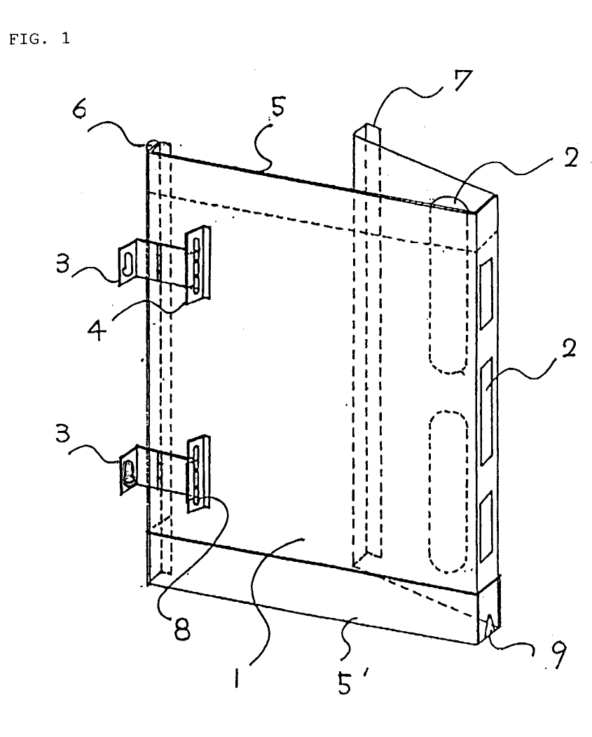

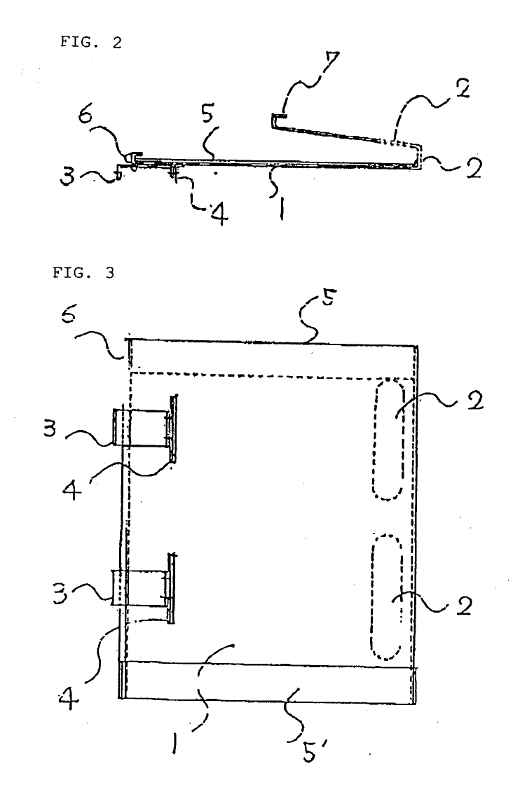

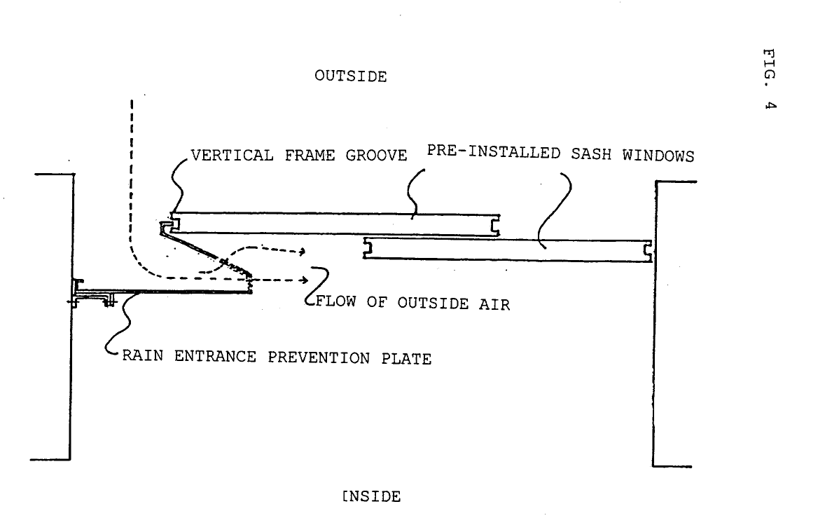

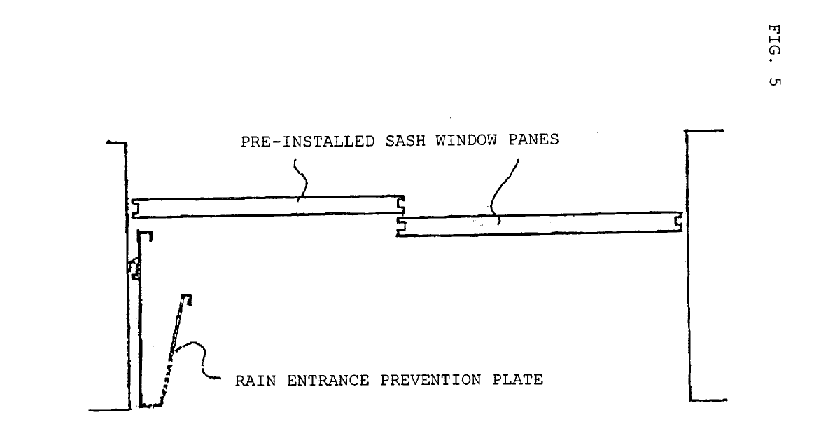

### BEST MODE FOR CARRYING OUT THE INVENTION

In order to describe the present invention in detail, explanation will be given in accordance with the attached drawings.

(A) Ventilation holes (2) are provided in one side of the folded surfaces of a rain entrance prevention plate (1), and hinges (3) are provided on one edge of the rain entrance prevention plate (1) so that this prevention plate can be opened and closed freely.

(B) Vertical sliding type fixing members (4) with elongated holes are provided in order that the coupling position of the rain entrance prevention plate (1) and the hinges (3) can be freely determined.

(C) The upper and lower gaps between the rain entrance prevention plate (1) and the pre-installed sash window are adjusted by sliding plates (5).

(D) Packing (6) is provided for preventing rain penetration.

(E) A folding vibration proofing device (7) in an inverted C-shape is inserted into a groove which is cut into the vertical frame member of the pre-installed sash window, and serves as a vibration proofing device for preventing vibration in the rain entrance prevention plate (1).

(F) An incision (9) is a vibration proofing device which is fastened to a rail.

The method of use of the present invention which is constituted as described above is as follows: wood screws in two locations on the hinge side of the pre-installed sash window frame are rotated counterclockwise two or three times so as to become loosened. Keyhole-shaped holes cut into the hinges (3) are fitted over the wood screws and the wood screws are tightened. The connection between the hinges (3) and the rain entrance prevention plate (1) is adjusted and fixed using the vertical sliding type fixing members (4).

The upper and lower gaps between the pre-installed sash window [and the rain entrance prevention plate (1)] are adjusted by the gap-adjusting sliding plates (5). Finally the folding vibration proofing device (7) in an inverted C-shape is inserted into the groove cut into the vertical frame member of the sash window to prevent vibration. When not in use, the device is folded back using the hinges (3) and stored.

### Industrial Applicability

By using the present invention, rain does not blow into a room when a window is opened during rainy weather, yet outside air enters through ventilation holes, as a result of which air circulation throughout a room is improved, whereby the environment is enhanced.

1. An auxiliary ventilation hole device for a sash window characterized in comprising:
ventilation holes (2) provided in one side of the folded surfaces of a rain entrance prevention plate (1);
gap adjusting sliding plates (5) provided along the upper and lower edges of said prevention plate;
packing (6) for preventing rain penetration;
a U-shaped vibration proofing device (7); and
a vibration proofing incision (9) on the lower portion of the device, and
said device being further provided on one edge with vertical sliding type fixing members (4) and hinges (3) attached thereto, so that the device can be opened and closed freely.
